(19) United States
(12) Patent Application Publication
(10) Pub. No.: US 2012/0027373 A1
(43) Pub. Date: Feb. 2, 2012

(54) HEAD-MOUNTED DISPLAY DEVICE HAVING INTERACTIVE FUNCTION AND METHOD THEREOF

(75) Inventors: PING-YANG CHUANG, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 12/949,810

(22) Filed: Nov. 19, 2010

(30) Foreign Application Priority Data
Jul. 29, 2010 (TW) 99125206

(51) Int. Cl. H04N 5/91

(52) U.S. Cl. 386/230; 386/E05.003

(57) ABSTRACT

A head-mounted display device having an interactive function is provided. The head-mounted display device includes a play unit, a display unit and a sensor unit. The play unit plays a portion of an image on the display unit. The display unit displays the image being played. The sensor unit senses a movement and a movement direction of the head-mounted display device. The play unit further adjusts the displayed portion of the image being played according the movement and the movement direction of the head-mounted display device.

### BACKGROUND

1. Technical Field

The present disclosure relates to head-mounted display devices and, particularly, to a head-mounted display device having an interactive function and a method thereof.

2. Description of Related Art

Head-mounted display device is widely used for viewing images. However, due to a limitation of a size of the display device, only a portion of the image is displayed on the display device, the user needs to use control keys such as, up/down and left/right keys, to move the image until the user can view the full image. It is inconvenient especially when hands of the user are not free.

### BRIEF DESCRIPTION OF THE DRAWINGS

FIG. 1 is a block diagram of a hardware infrastructure of a head-mounted display device in accordance with an exemplary embodiment.

FIG. 2 shows an image displayed by the head-mounted display device of FIG. 1.

FIG. 3 is a block diagram of a hardware infrastructure of the head-mounted display device in accordance with another embodiment.

FIG. 4 is a flowchart of a method having an interactive function implemented by the head-mounted display device in accordance with an exemplary embodiment.

### DETAILED DESCRIPTION

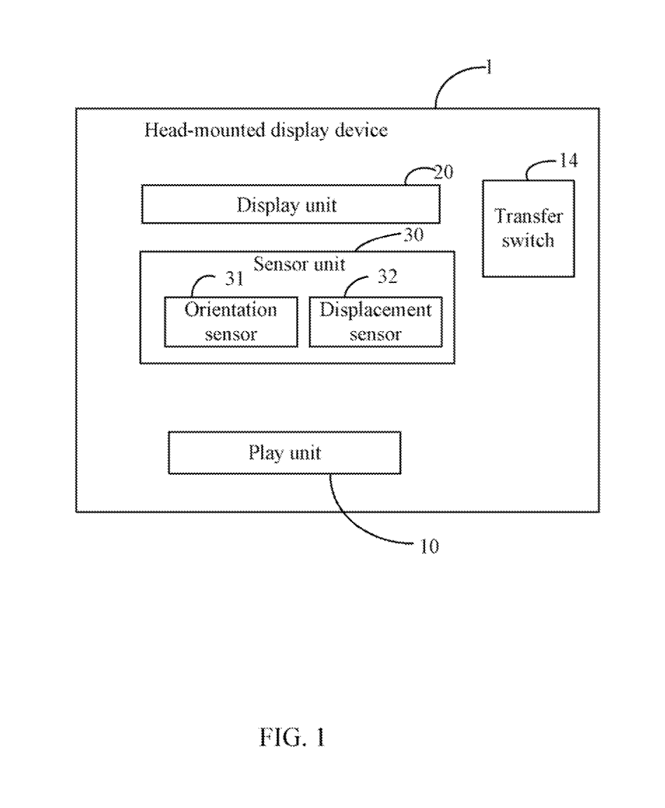

Referring to FIG. 1, a head-mounted display device 1 includes a play unit 10 and a display unit 20. The play unit 10 is configured for playing images. The display unit 20 is configured for displaying the images being played.

The head-mounted display device 1 further includes a sensor unit 30. The sensor unit 30 is configured for sensing a movement and a movement direction of the head-mounted display device 1 relative to an initial position of the head-mounted display device 1 when the head-mounted display device 1 moves. The play unit 10 is further configured for moving the played images according the sensed movement and the movement direction of the head-mounted display device 1 from the sensor unit 30.

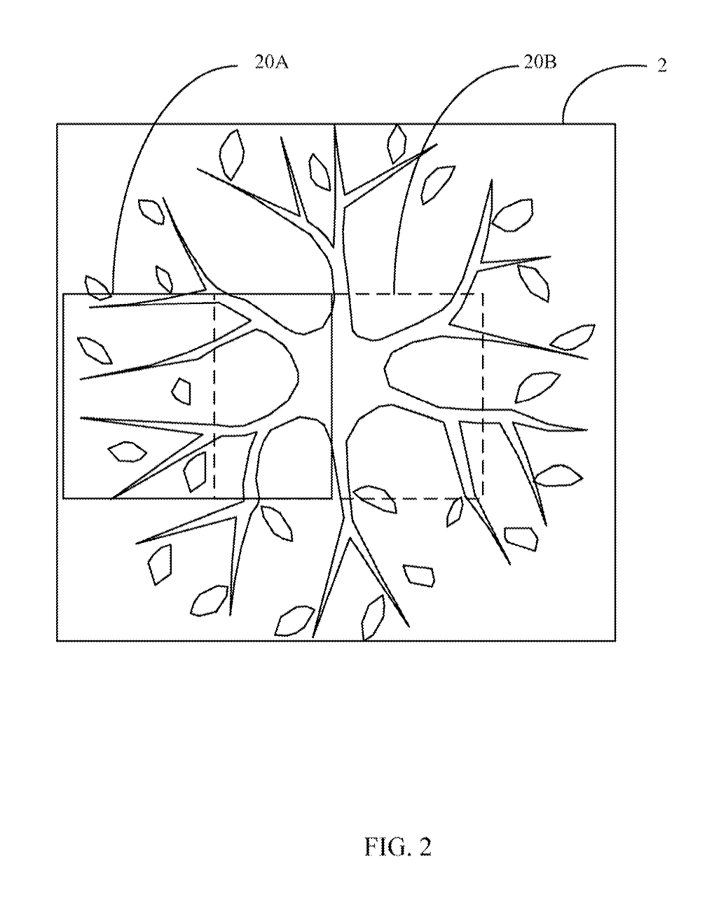

As shown in FIG. 2, due to a limitation of size of the display unit 20, the display unit 20 only displays a portion of the image 2 played by the play unit 10, e.g., a portion encircled by dotted-lines 20B. When the head-mounted display device 1 is moved towards the left side, the sensor unit 30 senses the movement and the movement direction of the head-mounted display device 1. The play unit 10 moves the viewable portion of the image being played towards the left side according to the sensed movement and the movement direction. After the image is moved by the play unit 10, the display unit 20 displays a different portion of the displayed image, e.g., a portion encircled by lines 20A.

The sensor unit 30 includes an orientation sensor 31 and a movement sensor 32. The orientation sensor 31 is able to sense the movement direction of the head-mounted display device 1 relative to the initial position of the head-mounted display device 1 when moved. In one embodiment, the orientation sensor 31 is an electronic compass. The movement sensor 32 is able to sense the movement of the head-mounted display device 1 relative to the initial position of the head-mounted display device 1 when moved. In one embodiment, the movement sensor 32 is a combination of a tri-axial acceleration transducer and a gyroscope. In other embodiment, the movement sensor 32 may be a combination of three acceleration transducers and a gyroscope.

In another embodiment, the head-mounted display device 1 further includes a transfer switch 14 which switches the sensor unit 12 between an enabled state and a disabled state. For example, when the user does not want the image being played to be moved according the movement direction and the movement of the head-mounted display device 1, the user operates the transfer switch 14 to switch the sensor unit 12 from the enabled state to the disabled state.

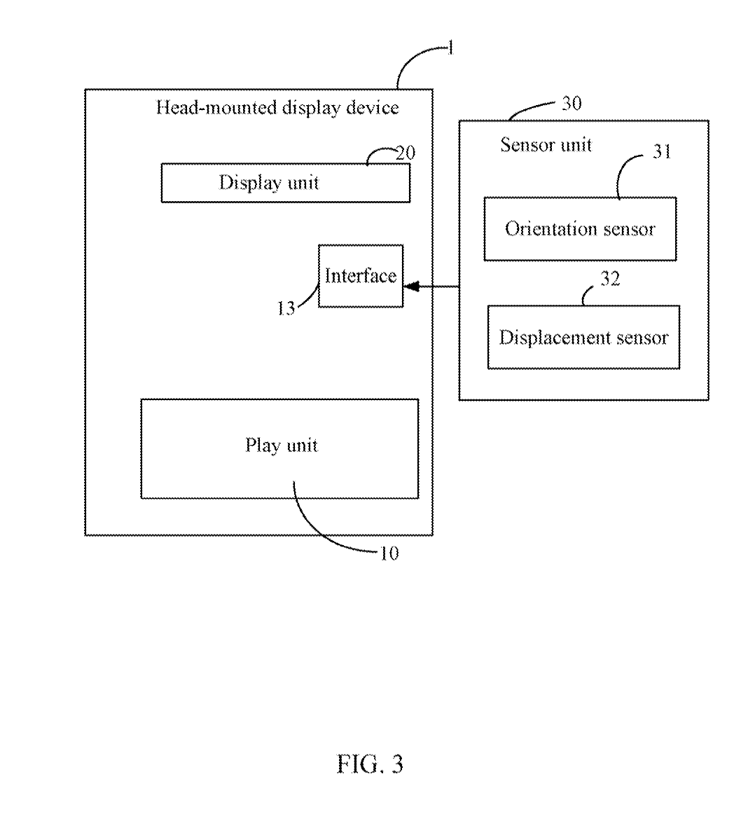

As shown in FIG. 3, in a second embodiment of the disclosure, the head-mounted display device 1 further includes an interface 13. The sensor unit 30 can be an independent sensor, which is connected to the head-mounted display device 1 through the interface 13.

In a third embodiment of the disclosure, the play unit 10 is further configured for detecting a format of the image being played, and comparing the format with a predetermined format to determine whether the image can be moved according the movement and the movement direction of the head-mounted display device 1. If the format of the image is not the predetermined format, it means that the image cannot be moved according the movement and the movement direction of the head-mounted display device 1, the play unit 10 will omit the movement and the movement direction information from the sensor unit 30.

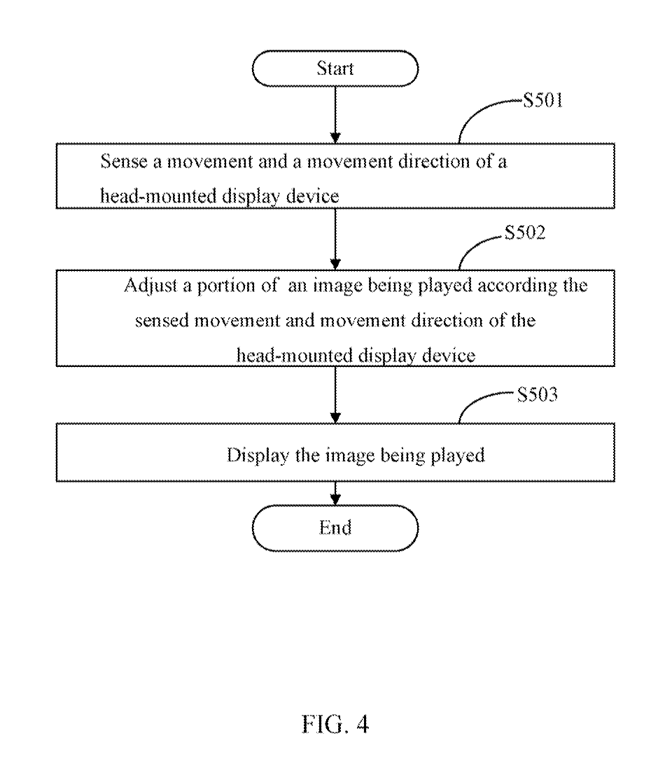

FIG. 4 is a flowchart of a method having an interactive function implemented by the head-mounted display devices of FIGS. 1 and 3, in accordance with an exemplary embodiment.

In step S501, the sensor unit 30 senses the movement and the movement direction of the head-mounted display device 1 relative to the initial position of the head-mounted display device 1.

In step S502, the play unit 10 adjusts a portion of the image being played according the sensed movement and the movement direction from the sensor unit 12.

In step S503, the display unit 20 displays the adjusted image.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A head-mounted display device having an interactive function, comprising:
a display unit;
a play unit able to play a portion of an image on the display unit; and
the display unit able to display the image being played; and
a sensor unit to sense a movement and a movement direction of the head-mounted display device relative to an initial position of the head-mounted display device;
wherein, the play unit further is to adjust the displayed portion of the image being played according the sensed movement and the movement direction from the sensor unit.

2. The head-mounted display device as described in claim 1, further comprising an interface, wherein the sensor unit is connected to the head-mounted display device through the interface when the sensor unit is an independent sensor.

3. The head-mounted display device as described in claim 1, wherein the play unit is further configured for detecting a format of the image being played, and comparing the detected format with a predetermined format to determine whether to adjust the image according the sensed movement and the movement direction of the head-mounted display device.

4. The head-mounted display device as described in claim 1, wherein the sensor unit comprises an orientation sensor and a movement sensor, the orientation sensor is able to sense the movement direction of the head-mounted display device when moving, and the movement sensor is able to sense the movement of the head-mounted display device when moving.

5. The head-mounted display device as described in claim 4, wherein the orientation sensor is an electronic compass.

6. The head-mounted display device as described in claim 4, wherein the movement sensor is a combination of a tri-axial acceleration transducer and a gyroscope.

7. The head-mounted display device as described in claim 4, wherein the movement sensor is a combination of three acceleration transducers and a gyroscope.

8. The head-mounted display device as described in claim 1, further comprising a transfer switch which switches the sensor unit between an enable state and a disable state.

9. A method having an interactive function implemented by a head-mounted display device, the method comprising:
sensing a movement and a movement direction of the head-mounted display device relative to an initial position of the head-mounted display device;
adjusting a portion of an image being played according the sensed movement and the movement direction; and
displaying the image being played.
